(19) United States
(12) Patent Application Publication
(10) Pub. No.: US 2008/0050237 A1
(43) Pub. Date: Feb. 28, 2008

(54) Rotor for wind turbine

(76) Inventor: Min Sung Lee, Pyeongtaek-City (KR)

Correspondence Address: W. NORMAN ROTH, 523 W. 6TH STREET, SUITE 707, LOS ANGELES, CA, 90014, US

(21) Appl. No.: 11/975,821

(22) Filed: Oct. 22, 2007

(30) Foreign Application Priority Data
May 26, 2006 (KR) KR10-2006-0047367
Mar. 27, 2007 (KR) PCT/KR2007/001486

(51) Int. Cl. F03D 3/06

(52) U.S. Cl. 416/197 A

(57) ABSTRACT

A rotor for a wind turbine includes a rotation shaft having a first flange and rotatably supported on a support frame; a single disc installed on the rotation shaft; wind guide parts defined through the disc to guide wind blowing on surfaces of the disc; first wind collecting parts formed around the wind guide parts on the surfaces of the disc to collect wind blowing on the surfaces of the disc; second wind collecting parts secured to the rotation shaft and the disc to collect wind; a first universal coupling having one end on which a second flange is provided to be coupled to the first flange and the other end which is formed with internal splines; and a propeller shaft having one end which is formed with external splines engaged with the internal splines and the other end which has a third flange and a second universal coupling.

### TECHNICAL FIELD

The present invention relates to a rotor for a wind turbine, and more particularly, to a rotor for a wind turbine, wherein the rotor is constructed to be reliably rotated on a rotation shaft while being optimized for variation in wind direction, wind speed and wind flow rate, which frequently change in a very irregular manner, so that breakage and malfunction of the rotor do not occur and noise generation is considerably reduced even when the rotor is exposed to strong wind.

### BACKGROUND ART

As is generally known in the art, a wind turbine is a kind of generator which transforms wind energy into mechanical energy using a rotor and generates electricity.

The wind turbine is a device capable of generating electricity using the wind, which is a clean energy source which can be unlimitedly used on the earth at no cost. The wind turbine can provide advantages in terms of cost due to improvement of price competitiveness and minimization of space requirements, in terms of the social environment because it supplies an alternative energy source that will outlast the exhaustion of fossil energy sources and thus preserve the earth's environment, and in terms of economics because the supply of electricity therefrom is stable and the dependency on imported energy sources can be reduced. In particular, recently, because governments are buying the electricity generated by private companies, the adoption of the wind power generation method is tending to increase.

When viewed from the outside, a wind turbine includes a rotor which transforms wind force into rotational energy, a rotation shaft which is rotated by the rotor, a tower which positions the rotor and the rotation shaft at a predetermined height above the ground, and a generator which is additionally installed, either over or under the tower, to generate electricity using the rotation force of the rotor.

The rotor which is mainly used in the conventional wind turbine has 2 to 6 blades. Rotors, in which blades have various shapes to rotate the rotation shaft using wind force, have been disclosed in the art.

However, while the conventional rotor having 2 to 6 blades has been substantially and widely used, in order to ensure the reliable generation of electricity, the overall length of each blade must be increased in order to increase the rotation diameter of the rotor. Therefore, a wide installation area is required, and the range of selection of useful locations is decreased.

In the case of the rotor in which blades having various shapes are provided, due to its structural characteristics, in order to receive an increased amount of wind, the size of the rotor should be increased in step with the increase in the number of rotors. As a consequence, the likelihood of the rotor to structurally wearing out under frequently and irregularly changing wind directions, wind speeds and wind flow rates increases. Also, due to the substantial load on the rotor, since the generation of electricity cannot be effectively conducted in small gusts of wind and in low-lying areas, it is necessary to install the rotor on high ground.

Specifically, in the event that the rotors are installed on a direct type wind turbine, in which an alternating current wind turbine is directly employed in an electrical system, difficulties may arise in that the system is likely to be directly influenced by changes in wind speed. Thus, in order to rotate the rotor at a substantially constant speed irrespective of wind speed, a separate control device must be installed to change the inclination of the rotor, thus increasing installation costs and the generation of noise.

In order to respond to these problems, the wind turbine disclosed in Korean Unexamined Patent Publication No. 1998-74542 includes at least one turbine which is located to extend in a vertical direction, rims or discs which are disposed on the turbine to be spaced apart from one another at regular intervals, and a plurality of wings which extend in a spiral direction around the rims or the turbine.

In the wind turbine disclosed in the above-noted patent document, while it is preferable for the plurality of wings to direct the flow of wind toward the turbine, if wind blows at a great speed from the direction of the upper and lower portions of the turbine at an incline and frequently and irregularly changes direction, as the wind comes into contact with the upper and lower surfaces of the rims or discs, which are spaced apart at regular intervals, a substantial load is applied to the rotation shaft, and the turbine installed on the rotation shaft is likely to be momentarily stopped or decreased in rotating force, whereby the efficient generation of electricity is deteriorated.

In particular, in the conventional wind turbine, each pair of wings delimits a funnel capable of serving as a collector for collecting wind at the outer ends thereof, and concentrates wind toward the turbine so that, when the wind moves toward the turbine, pressure can be preliminarily applied to the wind. Nevertheless, as the wind is likely to be discharged through the opening defined between the rotation shaft and the wings, it is difficult to continuously apply rotating force for each rotation of the rotation shaft, and thus the rotation shaft cannot be reliably rotated.

Further, the wind turbine disclosed in Korean Utility Model Registration No. 263185 comprises a cylindrical fan, and is constructed to generate electricity even under small gusts of wind and irrespective of wind direction. In the cylindrical fan, a plurality of impellers is installed between an upper disc and a lower disc at regular intervals so that electricity can be generated even under small gusts of wind, and without being influenced by wind direction.

Nonetheless, even in this wind turbine, when wind is directly brought into contact with the surfaces of the upper and lower discs, a substantial load is applied to the rotation shaft, and the impellers can be distorted. Consequently, the cylinder of the rotation shaft is likely to be momentarily stopped or decreased in rotating force, whereby efficient electricity generation can be deteriorated.

Furthermore, in order to respond to the above-noted problems, while various rotors and related devices for preventing the breakage of rotors and accelerating a rotation shaft without applying a substantial load have been disclosed in the art, since these rotors have increased sizes and additional component parts have inferior structural integrity, electricity generation efficiency is degraded in low areas or in urban areas, which have relatively low wind speeds or narrow spaces, and wind concentration is considerably degraded, by which wind force is lost and the efficiency of electricity generation is deteriorated.

Moreover, in the conventional rotors, in the case where wind speed is great, as during a typhoon or a season in which typhoons frequently occur, as a substantial load is continuously applied to the rotors and the rotation shafts, the rotors and the rotation shafts are likely to break. In consideration of this fact, if the size of the rotor is decreased in order to prevent the rotor from breaking under a great wind speed, for example during a typhoon, in order to thereby protect the wind turbine, it is impossible to generate electricity from a small gust of wind. Also, if a separate sensor for sensing wind speed is installed so that it is possible to automatically stop the wind turbine, the installation cost of the wind turbine is increased. Further, due to the high number of complicated attachments, the generation of noise is increased, and the possibility of the wind turbine breaking is increased, by which the efficiency of electricity generation is deteriorated.

### DISCLOSURE

[Technical Problem]

Accordingly, the present invention has been made in an effort to solve the problems occurring in the related art, and an object of the present invention is to provide a rotor for a wind turbine, wherein a plurality of wind guide holes is defined through a single disc, and a plurality of wind pockets is installed on the upper and lower surfaces of the disc in the regions of the wind guide holes, so that the rotor can be protected even when strong wind obliquely blows on the upper or lower surface of the disc while frequently and irregularly changing direction, so that the wind blowing from the upper and lower surfaces of the disc can be reliably guided to allow the rotor and the rotation shaft to be smoothly accelerated.

Another object of the present invention is to provide a rotor for a wind turbine, wherein a separate propeller shaft is connected to a rotation shaft having a first flange via a first universal coupling having a second flange so as to indirectly connect the rotation shaft to an accelerator or a generator using a second universal coupling, so that maintenance and repair work can be conveniently conducted, and various generators having different power generation capacity can be easily installed and operated as the occasion demands.

[Technical Solution]

In order to achieve the above objects, according to one aspect of the present invention, there is provided a rotor for a wind turbine, comprising a rotation shaft having a first flange on one end thereof, and rotatably supported by at least one bearing installed on a support frame; a single disc installed on the rotation shaft; a plurality of wind guide parts defined through the disc to guide wind blowing on upper and lower surfaces of the disc; a plurality of first wind collecting parts formed in regions of the wind guide parts on the upper and lower surfaces of the disc to collect wind blowing on the upper and lower surfaces of the disc and thereby rotate the rotation shaft; a plurality of second wind collecting parts secured to the rotation shaft and the disc to collect wind and thereby rotate the rotation shaft; a first universal coupling, one end of which has a second flange provided thereon to be coupled to the first flange and the other end of which is formed with internal splines; and a propeller shaft, one end of which is formed with external splines engaged with the internal splines of the first universal coupling and the other end of which has a third flange and a second universal coupling.

According to another aspect of the present invention, the wind guide parts comprise holes which are defined through the disc adjacent to the periphery of the disc so as to be spaced apart at regular angles.

According to another aspect of the present invention, the first wind collecting parts comprise wind pockets which are oppositely formed around the wind guide parts on the upper and lower surfaces of the disc to collect wind.

According to another aspect of the present invention, the second wind collecting parts comprise wings which are oppositely formed on the upper and lower surfaces of the disc and have first vertical edges secured to the rotation shaft and second horizontal edges secured to the upper and lower surfaces of the disc to extend close to first sides of the wind pockets, each wing having a contour which is curved to a predetermined depth.

According to another aspect of the present invention, third edges of the wings are secured to inclined frames, both ends of which are fastened to the rotation shaft and the upper and lower surfaces of the disc.

According to still another aspect of the present invention, one end of each hole extends beyond one opened end of each wind pocket to be exposed to the outside by a predetermined length.

According to a still further aspect of the present invention, each wind pocket is gradually decreased in the width and the height thereof to be tapered from one end to the other end thereof, and has a semicircular sectional shape.

[Advantageous Effects]

As is apparent from the above description, the rotor for a wind turbine according to the present invention provides advantages in that, even when wind blows on the upper and lower surfaces of the rotor while frequently and irregularly changing direction and speed, the resistance of the rotor is decreased, and the rotor can be reliably rotated by being optimized even for small gusts of wind. As a consequence, it is possible to rotate the rotor and maximize power generation efficiency even when unpredictable wind, which is generated by topographical features or seasonal factors or in a zone having very irregular surface contours due to the presence of a number of mountains and lakes, blows.

Further, since the rotor has a relatively simple configuration and its size can be changed depending upon the characteristic of an area, not only is the financial burden due to the installation of the rotor reduced, the generation of noise can also be minimized. Moreover, because environmental pollution and damage to the surrounding facilities do not occur, the rotor can form part of tourist attractions, and the incidence of disputes with local inhabitants over the installation of the rotor can be significantly decreased. Also, thanks to the fact that a first universal coupling having a second flange and a propeller shaft are sequentially installed to one end of a rotation shaft to connect the rotation shaft to a generator, maintenance and repair work can be conveniently and stably conducted, the generation of noise is remarkably reduced, and various generators having different power generation capacities can be easily installed and operated as the occasion demands.

### DESCRIPTION OF DRAWINGS

The above objects and other features and advantages of the present invention will become more apparent after a reading of the following detailed description taken in conjunction with the drawings, in which:

FIG. 1 is a perspective view illustrating the outer appearance of a rotor for a wind turbine in accordance with an embodiment of the present invention, with a support frame partially broken away;

FIG. 2 is a plan view illustrating the upper surface of the rotor for a wind turbine in accordance with the embodiment of the present invention, with the support frame partially broken away;

FIG. 3 is a front view illustrating the front surface of the rotor for a wind turbine in accordance with the embodiment of the present invention, with the support frame partially broken away; and

FIG. 4 is an enlarged cross-sectional view explaining the operation of the wind guide part and the first and second wind collecting parts of the rotor for a wind turbine in accordance with the embodiment of the present invention.

### BEST MODE

Reference will now be made in greater detail to a preferred embodiment of the invention, an example of which is illustrated in the accompanying drawings. Wherever possible, the same reference numerals will be used throughout the drawings and the description to refer to the same or like parts.

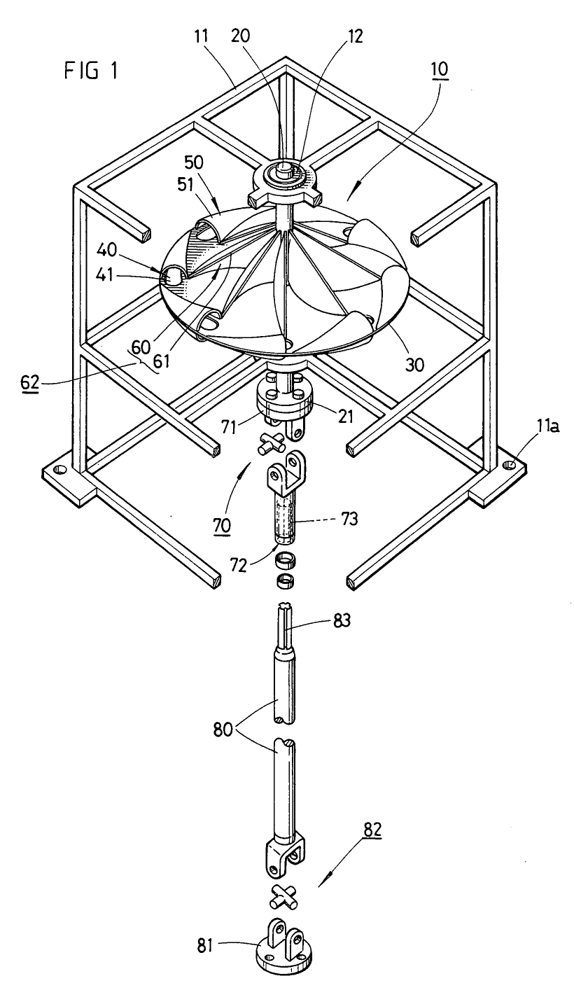

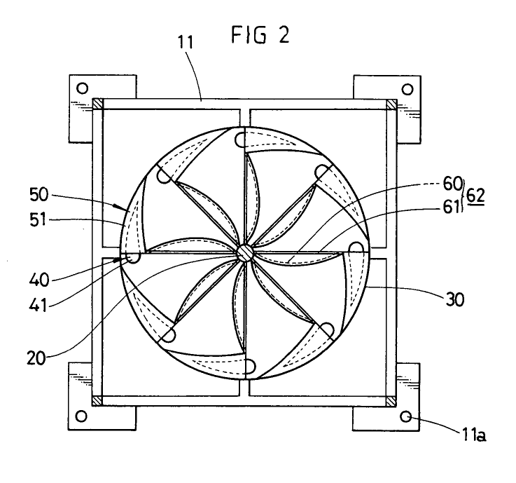

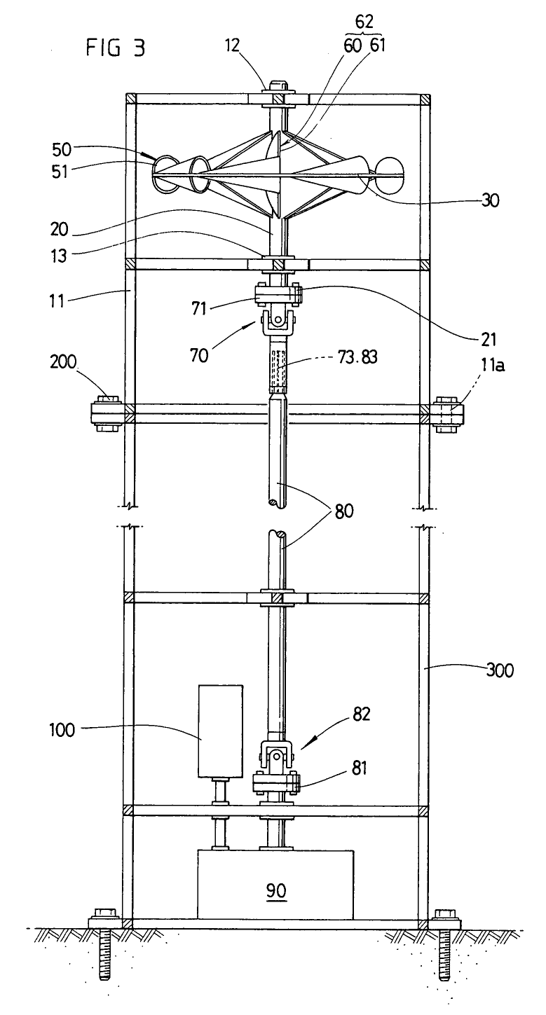

FIG. 1 is a perspective view illustrating the outer appearance of a rotor for a wind turbine in accordance with an embodiment of the present invention, with a support frame partially broken away, FIG. 2 is a plan view illustrating the upper surface of the rotor for a wind turbine in accordance with the embodiment of the present invention, with the support frame partially broken away, and FIG. 3 is a front view illustrating the front surface of the rotor for a wind turbine in accordance with the embodiment of the present invention, with the support frame partially broken away.

Referring to these drawings, the rotor 10 for a wind turbine in accordance with an embodiment of the present invention includes a rotation shaft 20 which is supported by bearings 12 and 13 on a support frame 11, a single disc 30 which is installed on the rotation shaft 20, a plurality of wind guide parts 40 which are defined through the disc 30, a plurality of first wind collecting parts 50 which are formed in the regions of the wind guide parts 40 on the upper and lower surfaces of the disc 30, a plurality of second wind collecting parts 60 which are secured to the rotation shaft 20 and the disc 30, a first universal coupling 70 which has a second flange 71, and a propeller shaft 80 which has a third flange 81 and a second universal coupling 82 and can be moved in the vertical direction.

A first flange 21 is secured to the other end of the rotation shaft 20. The first flange 21 is coupled to the second flange 71 by bolts. The other end of the universal coupling 70 is defined with an assembly hole 72, and internal splines 73 are formed on the inner surface of the assembly hole 72 to extend in the vertical direction. One end of the propeller shaft 80 is formed with external splines 83 which are engaged with the internal splines 73 of the universal coupling 70, and the other end of the propeller shaft 80 is formed with the third flange 81 and the second universal coupling 82. The propeller shaft 80 functions to transmit rotation force from the rotation shaft 20 to an accelerator 90 or a generator 100, which is separately provided.

After the rotation force is transmitted from the rotation shaft 20 to the propeller shaft 80 having the second universal coupling 82 via the first universal coupling 70, the rotation force is then transmitted to the accelerator 90 or the generator 100. Therefore, maintenance and repair work can be conveniently conducted, and various generators having different power generation capacity can be easily installed and operated as the occasion demands.

In the present invention, the single disc 30 comprises a single circular plate in order to reduce the resistance to strong wind. The rotation shaft 20 passes through the disc 30 to allow the disc 30 to be firmly secured thereto, and is rotatably supported by the bearings 12 and 13 on the support frame 11.

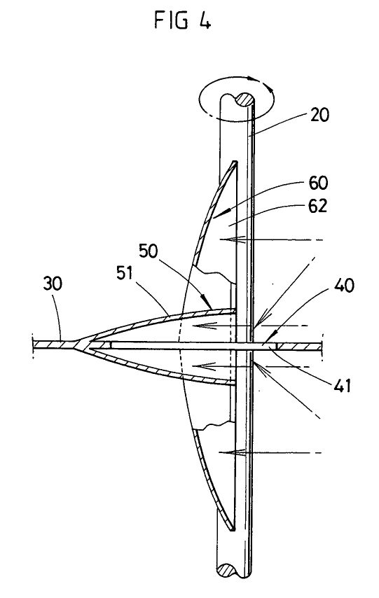

Referring to FIG. 4, the wind guide parts 40 comprise a plurality of holes 41 defined through the disc 30 adjacent to the periphery of the disc 30 to be spaced apart from one another at regular angles. As can be readily seen from FIG. 2, one end of each hole 41 extends beyond the opened one end of each wind pocket 51 to be exposed to the outside by a predetermined length. The reason for this resides in that, when a strong wind having a high wind speed blows on the upper and lower surfaces of the disc 30 to thus apply great force to the disc 30, the wind can be guided and immediately discharged upward or downward through the holes 41 which constitute the wind guide parts 40, to prevent excessive stress from being generated in the disc 30 by the strong wind which frequently changes direction.

The first wind collecting parts 50 comprise a plurality of wind pockets 51 which are oppositely formed in the regions of the wind guide parts 40 constituted by the holes 41 on the upper and lower surfaces of the disc 30 to collect wind. Because most of the strong wind rapidly passes through the holes 41, only the remaining portion of the strong wind is collected by the wind pockets 51 and is used to rotate the rotation shaft 20, whereby the rotor 10 is prevented from being broken and can be stably rotated even under strong wind.

At this time, each wind pocket 51 is gradually decreased in width and height to be tapered from one end to the other end thereof, and has a semicircular sectional shape. When strong wind rapidly passes through the holes 41, the wind, which skims the surface of the air pockets 51, can rapidly go past the wind pockets 51 without inducing resistance in the wind pocket 51. Also, due to the fact that the inner surface of each wind pocket 51 defines a semicircular space which is gradually decreased in width and height to be tapered from one end to the other end, the remaining portion of the strong wind, which lightly blows after strong wind has rapidly passed through the holes 41, can be collected deep inside the wind pockets 51 and be used to rotate the disc 30.

The second wind collecting parts 60 according to the present invention comprise a plurality of wings 62 which are formed on inclined frames 61, both ends of which are fastened to the rotation shaft 20 and close to first sides of the wind pockets 51 on the upper and lower surfaces of the disc 30. Each wing 62 has a contour which is curved to a predetermined depth, and therefore, collects wind so as to aid in rotating the rotation shaft 20. The inclined frames 61, which are fastened to the rotation shaft 20 and the upper and lower surfaces of the disc 30 and have an inclination angle of 45°, function to firmly support the disc 30 with respect to the rotation shaft 20 and securely hold the wings 62 with respect to the rotation shaft 20 and the disc 30. As a consequence, the inclined frames 61 prevent the disc 30 and the wings 62 from being broken even under great wind speed and irregularly changing wind direction, and, in cooperation with the wind pockets 51, which have semicircular sectional shapes and are gradually tapered, reduce the resistance to wind flow and the generation of noise.

The rotor 10 for a wind turbine in accordance with the present invention, constructed as mentioned above, is installed on the rotation shaft 20, which is supported by the bearings 12 and 13 on the support frame 11, which is mounted to a tower 300, etc. by bolts 200 locked into bolt holes 11a. When influenced by the wind direction, wind speed and wind flow rate, the rotor 10 rotates the rotation shaft 20. The rotation force of the rotation shaft 20 is transmitted to the propeller shaft 80 having the second universal coupling 82 via the first universal coupling 70, and then to the accelerator 90 or the generator 100, to be used for generating electrical energy.

According to the present invention, since the first universal coupling 70 and the second universal coupling 82 installed on the propeller shaft 80 absorb fine vibrations generated from the rotation shaft 20 and the propeller shaft 80, the generation of noise is suppressed, and breakdowns attributable to vibration can be prevented, so that the wind turbine including the rotor 10 can be protected. Also, because the propeller shaft 80 can be disassembled from the first universal coupling 70, maintenance and repair work can be conveniently conducted.

### INDUSTRIAL APPLICABILITY

As is apparent from the above description, the rotor for a wind turbine according to the present invention provides advantages in that, even when wind blows on the upper and lower surfaces of the rotor while frequently and irregularly changing direction and speed, the resistance of the rotor is decreased, and the rotor can be reliably rotated by being optimized even for small gusts of wind. As a consequence, it is possible to rotate the rotor and maximize power generation efficiency even when unpredictable wind, which is generated by topographical features or seasonal factors or in a zone having very irregular surface contours due to the presence of a number of mountains and lakes, blows.

Further, since the rotor has a relatively simple configuration and its size can be changed depending upon the characteristic of an area, not only is the financial burden due to the installation of the rotor reduced, the generation of noise can also be minimized. Moreover, because environmental pollution and damage to the surrounding facilities do not occur, the rotor can form part of tourist attractions, and the incidence of disputes with local inhabitants over the installation of the rotor can be significantly decreased. Also, thanks to the fact that a first universal coupling having a second flange and a propeller shaft are sequentially installed to one end of a rotation shaft to connect the rotation shaft to a generator, maintenance and repair work can be conveniently and stably conducted, the generation of noise is remarkably reduced, and various generators having different power generation capacities can be easily installed and operated as the occasion demands.

In the drawings and specification, there have been disclosed typical preferred embodiments of the invention and, although specific terms are employed, they are used in a generic and descriptive sense only and not for purposes of limitation, the scope of the invention being set forth in the following claims.

1. A rotor for a wind turbine, comprising:
a rotation shaft having a first flange on one end thereof, and rotatably supported by at least one bearing installed on a support frame;
a single disc installed on the rotation shaft;
a plurality of wind guide parts defined through the disc to guide wind blowing on upper and lower surfaces of the disc;
a plurality of first wind collecting parts formed in regions of the wind guide parts on the upper and lower surfaces of the disc to collect wind blowing on the upper and lower surfaces of the disc and thereby rotate the rotation shaft;
a plurality of second wind collecting parts secured to the rotation shaft and the disc to collect wind and thereby rotate the rotation shaft;
a first universal coupling having one end on which a second flange is provided to be coupled to the first flange and the other end which is formed with internal splines; and
a propeller shaft having one end which is formed with external splines engaged with the internal splines of the first universal coupling and the other end which has a third flange and a second universal coupling.

2. The rotor as set forth in claim 1, wherein the wind guide parts comprise holes which are defined through the disc adjacent to a periphery of the disc to be spaced apart at regular angles.

3. The rotor as set forth in claim 1, wherein the first wind collecting parts comprise wind pockets which are formed opposite each other on a basis of the wind guide parts on the upper and lower surfaces of the disc to collect wind.

4. The rotor as set forth in claim 1, wherein the second wind collecting parts comprise wings which are oppositely formed on upper and lower surfaces of the disc and have first vertical edges secured to the rotation shaft and second horizontal edges secured to the upper and lower surfaces of the disc to extend close to first sides of the wind pockets, each wing having a contour which is curved to a predetermined depth.

5. The rotor as set forth in claim 4, wherein third edges of the wings are secured to inclined frames, both ends of which are fastened to the rotation shaft and the upper and lower surfaces of the disc.

6. The rotor as set forth in claim 2, wherein one end of each hole extends beyond one opened end of each wind pocket to be exposed outside by a predetermined length.

7. The rotor as set forth in claim 3, wherein each wind pocket is gradually decreased in width and height to be tapered from one end to the other end thereof, and has a semicircular sectional shape.
